(19) United States
(12) Patent Application Publication
(10) Pub. No.: US 2024/0086367 A1
(43) Pub. Date: Mar. 14, 2024

(54) AUTOMATED METADATA GENERATION AND CATALOG HYDRATION USING DATA EVENTS AS A TRIGGER

(71) Applicant: Dell Products L.P., Round Rock, TX (US)

(72) Inventors: Joel Christner, El Dorado Hills, CA (US); Venkata Ramana Bandaru, George Town, TX (US); Sabu K. Syed, Austin, TX (US)

(21) Appl. No.: 17/931,410

(22) Filed: Sep. 12, 2022

(51) Int. Cl. G06F 16/16

(52) U.S. Cl. CPC G06F 16/164

(57) ABSTRACT

One example method includes receiving a data event notification, retrieving data to which the data event notification pertains, analyzing the data, based on the analyzing, generating metadata pertaining to the data, and transmitting the metadata to a repository. These operations may be performed automatically in response to receipt of the data event notification. The data event notification may likewise be generated automatically in response to implementation of the data event, which may be any of a data create, read, update, or delete, operation.

### FIELD OF THE INVENTION

Embodiments of the present invention generally relate to metadata generation. More particularly, at least some embodiments of the invention relate to systems, hardware, software, computer-readable media, and methods, for automatic generation of metadata in response to a triggering data change event.

### BACKGROUND

Metadata may be thought of as a fuel that powers business insights, analytics, and machine learning use cases. Today businesses must undertake a painful set of tasks to generate meaningful metadata from their data, and furthermore, store that metadata in a way that makes it queryable and consumable by users seeking to find data sets relevant to their tasks. The presence of useful, accurate, and accessible metadata creates a more useful and valuable data lake, whereas the lack of such metadata leads to having nothing more than a data swamp. Notwithstanding the importance of metadata, conventional approaches are problematic in terms of the generation and use of metadata.

For example, businesses often do not know when their data changes, from where the data changes, or what instigated the change. This is due at least in part to the lack of effective mechanisms for the generation and use of metadata concerning the data changes.

As another example, conventional approaches for the creation of metadata for a data asset are cumbersome, manual, and error prone. Thus, it is likely that the enterprise creating the metadata is not realizing the full value of metadata that could be collected with more effective approaches.

Finally, creation of a workflow that attempts to meet the needs of the enterprise most often requires a bespoke process. As such, there are significant disincentives for an enterprise to generate a customized metadata generation and collection process for each new situation. In more detail, such approaches may require crawling of a source repository periodically to identify new data, use of manual crafting of document parsing to generate content metadata, and manual crafting of connectors for persistence layers in which metadata should be stored. These processes are time consuming, and may be expensive as well, and thus provide significant disincentives to their implementation.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of example architecture according to some embodiments.

FIG. 2 discloses aspects of an example method for metadata generation according to some embodiments.

FIG. 3 discloses an example method according to some embodiments.

FIG. 4 discloses an example computing entity operable to perform any of the disclosed methods, processes, and operations.

### DETAILED DESCRIPTION OF SOME EXAMPLE EMBODIMENTS

Embodiments of the present invention generally relate to metadata generation. More particularly, at least some embodiments of the invention relate to systems, hardware, software, computer-readable media, and methods, for automatic generation of metadata in response to a triggering data change event.

In general, some example embodiments of the invention are directed to a reference architecture, and associated methods, by way of which the process of generating metadata and publishing metadata may be simplified, at least relative to conventional approaches, thereby yielding a relatively more efficient workflow and valuable data repository.

In some embodiments, a lightweight software layer, which may be referred to herein as a ‘metadata system,’ may be deployed that is integrated with facilities where data event notifications are automatically generated and sent from systems that hold data, and also integrated with a data catalog or other persistence layer capable of persisting metadata derived from the data incident to data event notifications. Such facilities may include, but are not limited to, data storage systems, or simply ‘storage systems.’ Storage systems according to some embodiments may automatically emit event notifications concerning data change events such as, for example, the writing of a new file. Metadata may be automatically generated in response to the event notification, and the generated metadata may be stored in a catalog and/or other metadata repository.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

For example, an advantageous aspect of some embodiments is that metadata may be automatically, rather than manually, generated in response to data state changes in a system. As another example, metadata may be generated in a way that does not impair or interfere with data flows in the system. Some embodiments may eliminate the need for creation of customized metadata generation schemes. Embodiments may employ metadata to maintain an up to date data representation of stored data. Various other advantages of some example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. General Aspects of Example Architectures and Environments

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data handling and data management operations, which may include, but are not limited to, data replication operations, IO replication operations, data read/write/delete operations, data movement operations, data deduplication operations, data backup operations, data restore operations, data cloning operations, data archiving operations, and disaster recovery operations. More generally, the scope of the invention embraces any operating environment in which the disclosed concepts may be useful.

At least some embodiments of the invention provide for the implementation of the disclosed functionality in existing backup platforms, examples of which include the Dell-EMC NetWorker and Avamar platforms and associated backup software, and storage environments such as the Dell-EMC DataDomain storage environment. In general however, the scope of the invention is not limited to any particular data backup platform or data storage environment.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, move, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM)

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention may be applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

### B. Aspects of An Example Embodiment

B.1 Architecture

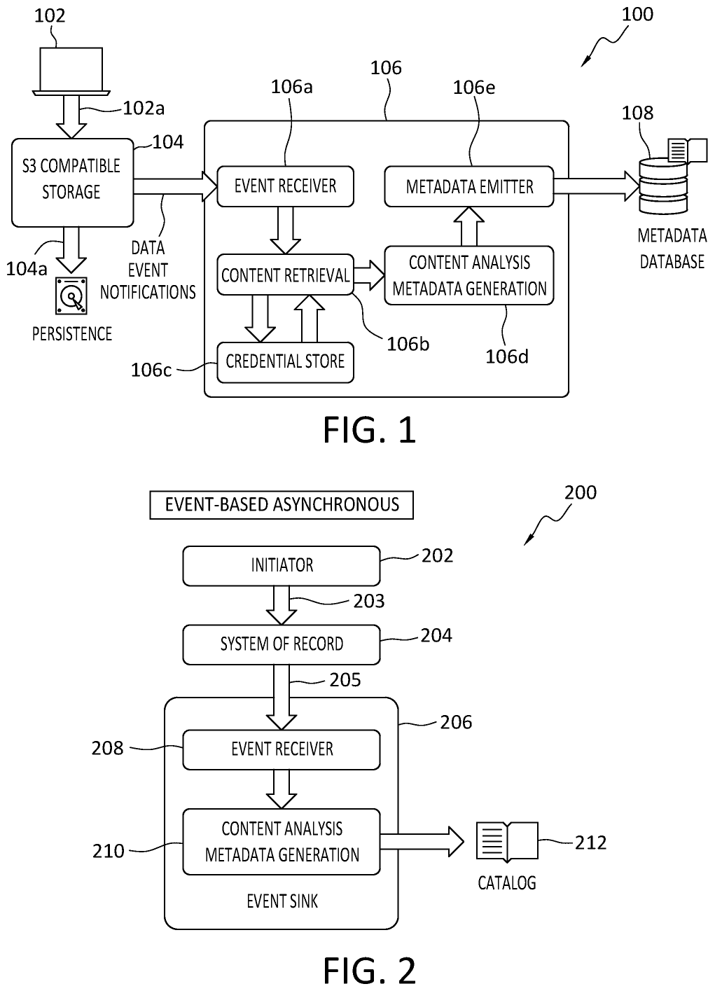

With particular attention now to FIG. 1, one example of an architecture for embodiments of the invention is denoted generally at 100. In general, the architecture 100 may be configured so that notifications about data events, also referred to as ‘data event notifications,’ occurring at an entity, or group of entities, are automatically received and processed by a metadata system that may communicate with, and/or comprise, a catalog and a metadata database. As such, the particular implementation of the architecture 100 disclosed in FIG. 1 is presented only by way of example, and is not intended to limit the scope of the invention in any way.

As shown in the example of FIG. 1, the architecture 100 may include various data operators 102, such as clients and applications for example. A ‘data operator’ may be any entity, including a data storage site, which may comprise hardware and/or software, that performs, and/or requests the performance of, operations with respect to data, where such operations may also be referred to herein as ‘data events.’ As used herein, ‘data event’ is intended to be broadly construed and may include, but is not limited to, data create, read, update, delete (CRUD) operations, as well as events involving the way data is handled, such as movement of data from one site to another, and data handling operations such as, but not limited to, copying, replication, encryption, decryption, compression, decompression, and masking, for example. Thus, a data event may comprise, but is not limited to, changes involving the content of the actual data itself, as well as operations concerning the handling and management of the data.

In the example of FIG. 1, a data operator 102 may transmit IOs (Input/Output) operation requests to a storage site 104. Where the IO relates, for example, to new or modified data, that data may be persistently stored at the storage site 104, and where the IO is a delete operation, the data identified in the IO may be deleted by the storage site 104. Thus, data events may occur at, and be implemented by, the storage site 104, or any other site or entity that handles data or performs operations with respect to data. The storage site 104 may, for example, be on-premises, off-premises, or a combination of the two. In the illustrated example, the storage site 104 is a cloud storage site, specifically, a cloud storage site that comprises Amazon S3—compatible storage. Here, two data paths 102a and 104a may be employed, with the data path 102a extending between the storage site 104 and the data operator 102, and data path 104a extending from the storage site 104 to the actual persistent storage elements of the storage site 104.

The example architecture 100 may further comprise a lightweight software layer 106, which may be referred to herein as a ‘metadata system,’ that may communicate with, the storage site 104. The metadata system 106 may be integrated within the storage site 104, or may be implemented as a stand-alone entity. Further, while the metadata system 106 may communicate with the storage site 104, the metadata system 106 is not, in some embodiments at least, located inline in the data paths 102a or 104a. As such, communications between the storage site 104 and the metadata system 106 may impose little or no load, such as a processing or communication bandwidth load, on the storage site 104 or the data operator 102. In these senses, at least, the metadata system 106 may be considered as being lightweight.

With continued reference to FIG. 1, the metadata system 106 may comprise various components, one of which may be an event receiver 106a that may, possibly automatically upon the occurrence of a data event, receive data event notifications, about data events, from the data operators 102 and/or the storage site 104. That is, the storage site 104 may automatically generate a data event notification, upon occurrence or implementation of a data event, and automatically transmit the data event notification to the event receiver 106a.

The metadata system 106 may further comprise a content retrieval module 106b that may, upon provision of a suitable credential as verified by a credential store 106c, retrieve content, or data, with which a data event notification is associated. The content, which may be retrieved from the storage site 104 and/or elsewhere, may be analyzed by a content analysis and metadata generation module 106d. Metadata generated based on the analysis of the content may be emitted by a metadata emitter module 106e, such as to a metadata database 108 and/or a catalog, for example.

Turning next to FIG. 2, an approach for event-based asynchronous metadata generation, and a corresponding structure 200, are disclosed. As used here, asynchronous embraces the notion that in some embodiments, metadata may not necessarily be generated at the same time as, or in synchronization with, the occurrence of data events. For example, metadata may be generated as time and resources allow, rather than based on when the data events occur. Thus, metadata relating to data events may be generated at unexpected times without any particular relation to the time when the data events occur.

As shown in FIG. 2, an initiator 202, such as a client or application for example, may initiate a request 203 for an operation that implicates one or more data events. The request may be directed to a system of record 204, such as a storage site or a client for example. The system of record 204, in turn, may perform one or more data events. For example, a client application may create a new data object, or a storage site may store a data object. Upon occurrence of the data event, the system of record 204 may generate and transmit, possibly automatically, an event notification 205 comprising information indicating the nature of the data event, the identity of the initiator 202, and other information, such as where/when the data event occurred.

The event notification 205 may be received at an event sink 206 that may comprise an event receiver 208, and a content analysis and metadata generator 210. The content analysis and metadata generator 210 may parse the event notification 205 to identify the underlying data, or content, and may then analyze that content. Based on the analysis, the content analysis and metadata generator 210 may then generate corresponding data which may be transmitted by the event sink 206 to a catalog or database 212.

B.2 Operational and Functional Aspects of Some Embodiments

With continued attention to the examples of FIGS. 1 and 2, further details are provided concerning various operational and functional aspects of some example embodiments. As noted earlier herein, some embodiments are directed to a lightweight software layer that may be integrated with facilities, such as data storage facilities for example, where data event notifications are automatically generated and sent from systems that hold data, and the software layer may additionally be integrated with a data catalog or other persistence layer capable of persisting metadata derived from the data incident to data event notifications resulting from the occurrence of data events.

When a metadata system according to some embodiments receives a notification of a data change event, various events may occur, based on the type of data change event. Note that the following two data events are presented only by way of example, and are not intended to limit the scope of the invention in any way. Further, the concepts discussed in connection with these examples may be extendible to any of the other data events disclosed herein, or apparent from this disclosure.

For example, where the data change event includes the creation of a new data object, the new object may be retrieved, by the integrated software layer, using a client natural to the system holding the data. For example, a file server may be used to retrieve a file, RESTful API or similar to retrieve an object, or a SQL query to retrieve an item from a DBMS (database management system). As well, the metadata held by the system holding the data may be retrieved by the integrated software layer. For example, a file server that includes one or more files may also hold respective for those files. The origin metadata, that is, metadata held by the system that holds the corresponding data, in addition to the data contained within the object, may then be used by the integrated software layer to generate metadata, which is then emitted to a data catalog or other persistence layer.

Another example data event is the deletion of a data object. In this case, the metadata system may connect to a data catalog or other persistence layer and update existing records to indicate that the object was deleted from its source storage repository.

In terms of the metadata generated by a metadata system according to some embodiments, such metadata may be standard, examples of which include, but are not limited to, geometric analysis, extraction of key terms, extraction/derivation of the schema, and creation of an inverted index for the content. Alternatively, metadata generated by an example metadata system may be rule-based using one or more user-defined rules and/or one or more pre-defined system rules. For example, a user of the metadata system could specify “if the word ‘lightning’ is found in the document, add a key-value pair to the metadata such as {“projectLightning”: true}.”

In some embodiments, a metadata system may be programmatically amended, that is, a user may write their own code to override, or supplement, a default metadata generation and handling scheme of the metadata system. To illustrate, a user may amend the metadata system to support behavior that is different than the behavior described in the metadata system for a given primitive, that is, a fundamental data operation such as a CRUD for example. As well, the user may amend the metadata system to support different primitives, such as that the access control list of a file has been changed. In this way, a user may be able to generate customized definitions of what constitutes a data event. As such, example embodiments may be highly flexible in terms of what events may be used to trigger metadata generation. Further, a metadata system according to some embodiments may be used by query engines to select optimized query plans based on the metadata, examples of which may include a volume of the data being queried, cardinality of the data, location, and owner of the data.

### C. Further Discussion

As will be apparent from this disclosure, example embodiments of the invention may possess a variety of useful features and advantages. For example, a metadata system according to some embodiments may automatically react to data events, such as data state changes, by generating net-new metadata and loading the newly generated metadata into a persistence layer, rather than having data users perform this task manually. As another example, some embodiments of a metadata system may take advantage of event interfaces used by systems of record, such as data storage systems for example, and may take action based on those events, rather than requiring direct integration into the data path(s) of those systems. Further, some embodiments of a metadata system may enable a set of general metadata attributes to be generated over new data, in addition to metadata generated based on user-supplied rules indicating what key-value pairs should be included in the metadata based on conditions found in the origin content. As a final example, should data be deleted on an origin system, or system of record, some embodiments of a metadata system may receive an event notification and take action to delete the persisted metadata, invalidate it, or amend the metadata to indicate that the associated data asset is no longer available. This means the catalog may maintain metadata, and may thus also maintain an up-to-date representation of the actual stored data assets.

### D. Example Use Case

Following is an example use case intended to illustrate aspects of one or more example embodiments. This use case is not intended to limit the scope of the invention in any way.

Alice has an application that periodically writes data to an S3 bucket exposed by ObjectScale. Alice wants to know the schema of each of these objects, and additionally, wants to know if any of the objects are related to an internal confidential project named “Project Lightning.” Alice deploys the metadata system, which listens to the event bus where ObjectScale emits events. When new data is written to the S3 bucket, Alice's application is notified by the ObjectScale Event Notification System and the application retrieves the object and its metadata, and generates metadata from the contents of the object. The system evaluates the metadata generation rules written by Alice which indicate “if you find the terms ‘project’ and ‘lightning’ within one token distance of another, and the term ‘confidential’ exists within the object, then add metadata annotations {“projectLightning”: true} and {“confidential”: true}.” This metadata is loaded into a PostgreSQL instance in Alice's data warehouse where now she can perform a search such as “show me all ISON documents that are related to project lightning, are confidential, and have the schema element ‘customerName’ within them.”

### E. Example Methods

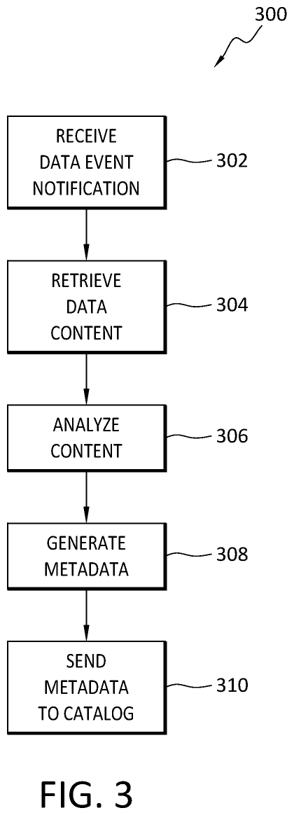

It is noted with respect to the disclosed methods, including the example method of FIG. 3, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 3, an example method 300 according to some embodiments is disclosed. Part, or all, of the method 300 may be performed by a metadata system, as disclosed herein. The metadata system that performs part or all of the method 300 may, or may not, be integrated into a system that creates and/or handles data, such as a data storage system for example.

The method 300 may begin when a metadata system receives a notification 302 that a data event has occurred, such as, for example, data has been created, modified, and/or deleted, in, or in association with, a system of record such as a data storage system. In some instances, the notifications may be automatically generated. After receipt of the notification, the metadata system may retrieve 304, or direct the retrieval of, the data to which the notification pertains.

When the data has been retrieved, the metadata system may analyze 306 the data. The analysis 306 may comprise determining the nature or type of the content, and based on that determination, identifying one or more metadata generation rules that apply to the content. Next, the metadata system may generate metadata 308 according to the metadata generation rules and/or based on other considerations.

The metadata that has been generated 308 may then be transmitted 310 by the metadata system to a catalog and/or other repository. The catalog or other repository may enable user access, such as by queries for example, to the stored metadata. As well, the metadata system may transmit updates, such as new and/or modified metadata, to the catalog and/or other repository, when a change, such as a CRUD event for example, has occurred with respect to the associated data.

Note that any, or all, of the operations 304, 306, 308, and 310, may be performed automatically upon receipt 302 of the data event notification. Thus, in some embodiments, the receipt 302 of the data event notification may operate as a trigger that automatically triggers the generation of metadata.

### F. Further Example Embodiments

Following are some further example embodiments of the invention. These are presented only by way of example and are not intended to limit the scope of the invention in any way.

Embodiment 1. A method, comprising: receiving a data event notification; retrieving data to which the data event notification pertains; analyzing the data; receiving a data event notification; retrieving data to which the data event notification pertains; analyzing the data; based on the analyzing, generating metadata pertaining to the data and/or making a metadata change pertaining to the data; and transmitting the new metadata and/or changed metadata to a repository.

Embodiment 2. The method as recited in embodiment 1, wherein the generated metadata is different from metadata concerning the data, and which existed prior to creation of the generated metadata.

Embodiment 3. The method as recited in any of embodiments 1-2, wherein the metadata is generated according to a rule.

Embodiment 4. The method as recited in any of embodiments 1-3, wherein the recited operations are performed out-of-band with respect to a data path extending between entities that were involved in performance of a data event that corresponds to the data event notification.

Embodiment 5. The method as recited in any of embodiments 1-4, wherein the repository is automatically updated when a change is made to the data, and/or when the data is deleted.

Embodiment 6. The method as recited in any of embodiments 1-5, wherein the data event notification is received from a data storage site.

Embodiment 7. The method as recited in any of embodiments 1-6, wherein one or more of the retrieving, analyzing, generating, and transmitting, are performed automatically in response to receipt of the data event notification.

Embodiment 8. The method as recited in any of embodiments 1-7, wherein the recited operations are performed by a software layer that is integrated together with an entity that generated the data event notification, and is also integrated together with the repository.

Embodiment 9. The method as recited in any of embodiments 1-8, wherein the data event notification pertains to an operation performed on the data, and/or to an operation performed in handling the data.

Embodiment 10. The method as recited in any of embodiments 1-9, wherein the analyzing comprises determining if a metadata generation rule is applicable to the data.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

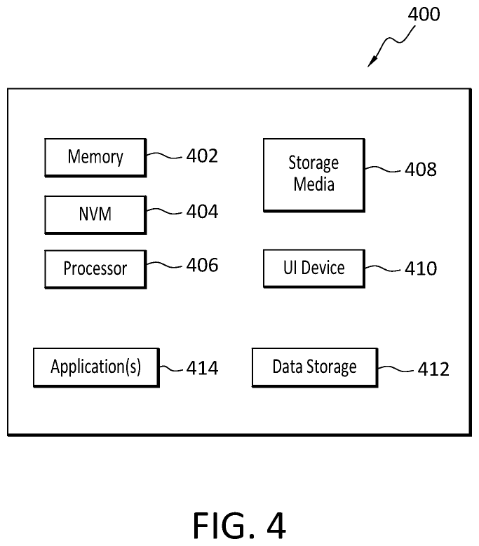

With reference briefly now to FIG. 4, any one or more of the entities disclosed, or implied, by FIGS. 1-3 and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI (user interface) device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method, comprising:
receiving a data event notification;
retrieving data to which the data event notification pertains in response to reception of the data event notification;
analyzing the data;
based on the analyzing, generating metadata pertaining to the data and/or making a metadata change pertaining to the data; and
transmitting new metadata and/or changed metadata to a repository,
wherein the metadata is generated according to a rule that the metadata includes a key-value pair when a condition is found in the data.

2. The method as recited in claim 1, wherein the generated metadata is different from metadata concerning the data, and which existed prior to creation of the generated metadata.

3. (canceled)

4. The method as recited in claim 1, wherein the recited operations are performed out-of-band with respect to a data path extending between entities that were involved in performance of a data event that corresponds to the data event notification.

5. The method as recited in claim 1, wherein the repository is automatically updated when a change is made to the data, and/or when the data is deleted.

6. The method as recited in claim 1, wherein the data event notification is received from a data storage site.

7. The method as recited in claim 1, wherein one or more of the retrieving, analyzing, generating, and transmitting, are performed automatically in response to receipt of the data event notification.

8. The method as recited in claim 1, wherein the recited operations are performed by a software layer that is integrated together with an entity that generated the data event notification, and is also integrated together with the repository.

9. The method as recited in claim 1, wherein the data event notification pertains to an operation performed on the data, and/or to an operation performed in handling the data.

10. The method as recited in claim 1, wherein the analyzing comprises determining if the rule is applicable to the data.

11. A non-transitory storage medium having stored therein instructions that are executable by one or more hardware processors to perform operations comprising:
receiving a data event notification;
retrieving data to which the data event notification pertains in response to reception of the data event notification;
analyzing the data;
based on the analyzing, generating metadata pertaining to the data and/or making a metadata change pertaining to the data; and
transmitting new metadata and/or changed metadata to a repository,
wherein the metadata is generated according to a rule that the metadata includes a key-value pair when a condition is found in the data.

12. The non-transitory storage medium as recited in claim 11, wherein the generated metadata is different from metadata concerning the data, and which existed prior to creation of the generated metadata.

13. (canceled)

14. The non-transitory storage medium as recited in claim 11, wherein the recited operations are performed out-of-band with respect to a data path extending between entities that were involved in performance of a data event that corresponds to the data event notification.

15. The non-transitory storage medium as recited in claim 11, wherein the repository is automatically updated when a change is made to the data, and/or when the data is deleted.

16. The non-transitory storage medium as recited in claim 11, wherein the data event notification is received from a data storage site.

17. The non-transitory storage medium as recited in claim 11, wherein one or more of the retrieving, analyzing, generating, and transmitting, are performed automatically in response to receipt of the data event notification.

18. The non-transitory storage medium as recited in claim 11, wherein the recited operations are performed by a software layer that is integrated together with an entity that generated the data event notification, and is also integrated together with the repository.

19. The non-transitory storage medium as recited in claim 11, wherein the data event notification pertains to an operation performed on the data, and/or to an operation performed in handling the data.

20. The non-transitory storage medium as recited in claim 11, wherein the analyzing comprises determining if the rule is applicable to the data.
